(19) United States
(12) Patent Application Publication
(10) Pub. No.: US 2017/0270556 A1
(43) Pub. Date: Sep. 21, 2017

(54) METHOD AND APPARATUS FOR PROVIDING A HOSPITALITY LOYALTY PLATFORM

(71) Applicant: Resynct LLC, Brooklyn, NY (US)

(72) Inventor: Jonathan EKLUND, Brooklyn, NY (US)

(21) Appl. No.: 15/463,893

(22) Filed: Mar. 20, 2017

Related U.S. Application Data
(60) Provisional application No. 62/310,133, filed on Mar. 18, 2016.

(51) Int. Cl. G06Q 30/02; G06Q 10/02

(52) U.S. Cl. CPC G06Q 30/0226; G06Q 10/02; G06Q 50/12

(57) ABSTRACT

An approach is provided for providing points to at least one registered user for acquisition of a registered service. The approach involves receiving a request from at least one user for at least one service. The approach also involves providing reservation information for one or more participating service providers for the at least one service based, at least in part, on preference information of the at least one user. The approach further involves calculating one or more points available to the at least one user based, at least in part, on a reservation for the at least one service from at least one participating service provider. The approach also involves providing the one or more points to the at least one user based, at least in part, on confirmation of the reservation for the at least one service. The approach further involves exchanging the one or more points for a discount, a partial payment, or a combination thereof for the at least one service based, at least in part, on a pre-set criteria, a purchase amount of the at least one service, or a combination thereof.

### RELATED APPLICATION

This application is a continuation of U.S. Patent Application Ser. No. 62/310,133, filed Mar. 18, 2016, entitled “Method and Apparatus for Providing a Hospitality Loyalty Platform”, which is incorporated herein by reference in its entirety.

### BACKGROUND

Businesses (e.g., participating airlines, hotels, credit card companies, etc.) often give their members (e.g. consumers) reward points as an incentive to increase consumer spending on goods or services, for recognition of their loyalty, and the like. However, such loyalty programs often can be technologically complex and burdensome to implement. For example, multiple systems belonging to different entities such as hotels, consumers, booking engine providers, etc. typically must interoperate to provide for earning and redeeming loyalty points or other loyalty incentives.

Therefore, there is a need for an approach for providing a hospitality loyalty platform for universal and customizable implementation by different hospitality entities.

### SOME EXAMPLE EMBODIMENTS

According to one embodiment, a method comprises receiving a request from at least one user for at least one service. The method also comprises providing reservation information for one or more participating service providers for the at least one service based, at least in part, on preference information of the at least one user. The method further comprises calculating one or more points available to the at least one user based, at least in part, on a reservation for the at least one service from at least one participating service provider. The method also comprises providing the one or more points to the at least one user based, at least in part, on confirmation of the reservation for the at least one service. The method further comprises exchanging the one or more points for a discount, a partial payment, or a combination thereof for the at least one service based, at least in part, on a pre-set criteria, a purchase amount of the at least one service, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to receive a request from at least one user for at least one service. The apparatus is also caused to provide reservation information for one or more participating service providers for the at least one service based, at least in part, on preference information of the at least one user. The apparatus is further caused to calculate one or more points available to the at least one user based, at least in part, on a reservation for the at least one service from at least one participating service provider. The apparatus is also caused to provide the one or more points to the at least one user based, at least in part, on confirmation of the reservation for the at least one service. The apparatus is further caused to exchange the one or more points for a discount, a partial payment, or a combination thereof for the at least one service based, at least in part, on a pre-set criteria, a purchase amount of the at least one service, or a combination thereof.

According to another embodiment, a computer-readable storage medium carries one or more sequences of one or more instructions which, when executed by one or more processors, cause, at least in part, an apparatus to receive a request from at least one user for at least one service. The apparatus is also caused to provide reservation information for one or more participating service providers for the at least one service based, at least in part, on preference information of the at least one user. The apparatus is further caused to calculate one or more points available to the at least one user based, at least in part, on a reservation for the at least one service from at least one participating service provider. The apparatus is also caused to provide the one or more points to the at least one user based, at least in part, on confirmation of the reservation for the at least one service. The apparatus is further caused to exchange the one or more points for a discount, a partial payment, or a combination thereof for the at least one service based, at least in part, on a pre-set criteria, a purchase amount of the at least one service, or a combination thereof.

According to another embodiment, an apparatus comprises means for receiving a request from at least one user for at least one service. The apparatus also comprises means for providing reservation information for one or more participating service providers for the at least one service based, at least in part, on preference information of the at least one user. The apparatus further comprises means for calculating one or more points available to the at least one user based, at least in part, on a reservation for the at least one service from at least one participating service provider. The apparatus also comprises means for providing the one or more points to the at least one user based, at least in part, on confirmation of the reservation for the at least one service. The apparatus further comprises means for exchanging the one or more points for a discount, a partial payment, or a combination thereof for the at least one service based, at least in part, on a pre-set criteria, a purchase amount of the at least one service, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing points to at least one registered user for acquisition of a registered service, wherein payment may be partially made through automated redemption of the points from at least one point account, according to one example embodiment;

FIG. 2 is a diagram of the components of the channel manager platform 109, according to one example embodiment;

FIG. 3 is a flowchart of a process for providing points to a registered user for acquisition of a registered service, and exchanging the points as a partial payment for the registered service, according to one embodiment;

FIG. 4 is a flowchart of a process for calculating points for a registered user, and depositing the points in a point account associated with the registered user, according to one embodiment;

FIG. 5 is a flowchart of a process for selling one or more points by the participating service providers, according to one embodiment;

FIG. 6 is a flowchart of a process for storing reservation information, and updating status information, according to one embodiment;

FIG. 7 is a flowchart of a process for monitoring exchange rate of currencies associated with participating service provider and the user, according to one embodiment;

FIG. 8 is a diagram that represents a registration workflow, according to various embodiments;

FIG. 9 is a diagram utilized in the processes of earning points for at least one registered user, according to various embodiments;

FIG. 10 is a diagram utilized in the processes of redeeming points for at least one registered user, according to various embodiments;

FIG. 11 is a flowchart of a process that depicts the reservation life cycle, according to one example embodiment;

FIGS. 12A-12C illustrate diagrams of a user interface for user registration and making reservations, according to various example embodiments;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for providing points to at least one registered user for acquisition of a registered service, wherein payment may be partially made through automated redemption of the points from at least one point account are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

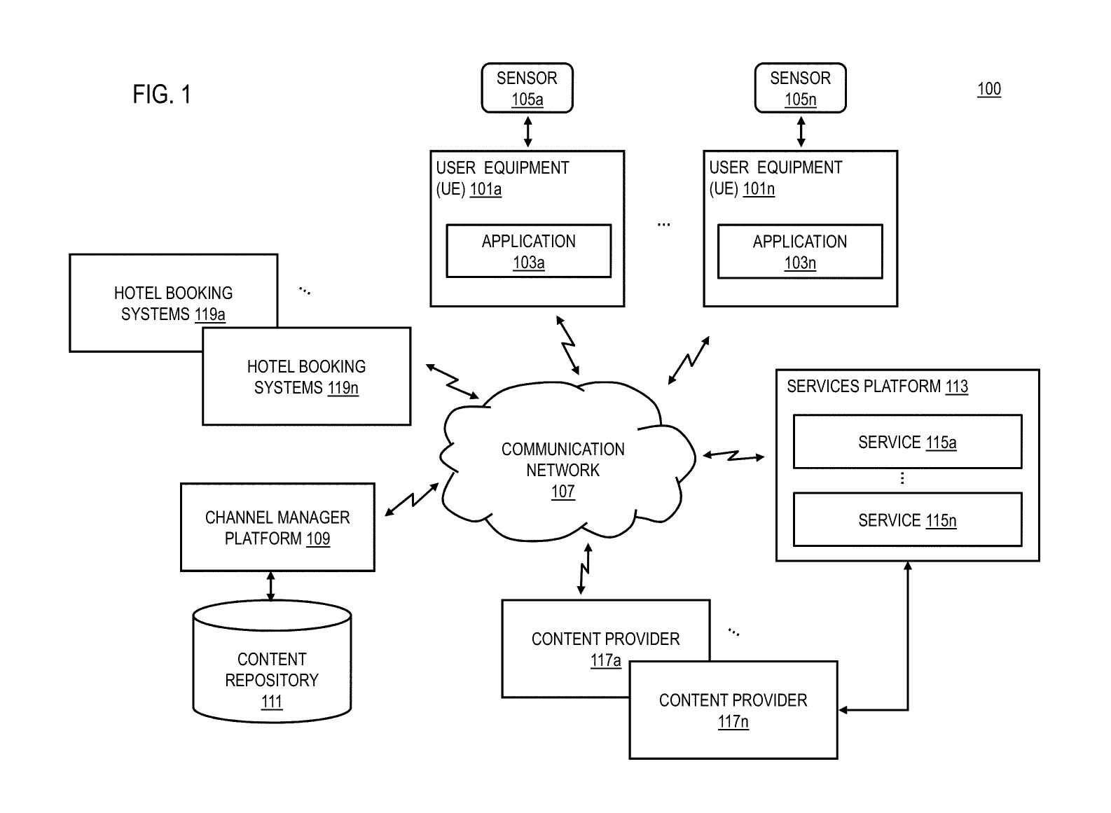

FIG. 1 is a diagram of a system capable of providing points (i.e., loyalty points, reward points, etc.) to at least one registered user for acquisition of a registered service, wherein payment may be partially made through automated redemption of the points from at least one point account, according to one embodiment. Loyalty/reward programs are implemented to retain existing customers, attract new customers, and increase the use of a service by the existing customers. In a loyalty/reward program a customer earns points for undertaking certain activities (e.g., purchasing certain services), and these points may be redeemed by the members while purchasing any future services. However, the redemption process through a ticketing agency or on an exchange is time-consuming and annoying for the consumer. The users wants to be able to redeem points in real-time. Further, users are not allowed to redeem small amount of points which is highly inconvenient. In addition, users cannot redeem their points obtained from a particular hotel in other hotels.

To address these problems, a system 100 of FIG. 1 introduces the capability for a registered user to make payment for a registered service partially through automated redemption of the points from his/her point account. The system 100 also enables users to redeem small amount of points amongst one or more participating hotels.

As shown in FIG. 1, the system 100 comprises of UE 101. In one embodiment, the UE 101 may include, but is not restricted to, any type of a mobile terminal, wireless terminal, fixed terminal, or portable terminal. Examples of the UE 101, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 101 may facilitate various input means for receiving and generating information, including, but not restricted to, a touch screen capability, a keyboard and keypad data entry, a voice-based input mechanism, and the like. Any known and future implementations of the UE 101 may also be applicable.

The UE 101 may further include applications 103. Further, the applications 103 may include various applications such as, but not restricted to, content provisioning application, social networking application, calendar applications, multimedia application, camera/imaging application, media player application, location-based service application, and the like. In one embodiment, the applications 103 are installed within the UE 101.

The system 100 also includes one or more sensors 105, which can be implemented, embedded or connected to the UE 101. The sensors 105 may be any type of sensor. In certain embodiments, the sensors 105 may include, for example, but not restricted to, a global positioning sensor (GPS) for gathering location data, a network detection sensor for detecting wireless signals or receivers for different short-range communications (e.g., Bluetooth, Wi-Fi, Li-Fi, Near Field Communication (NFC) etc.), temporal information sensors (e.g., additional discount defined by a hotel for specific dates), a camera/imaging sensor for gathering image data, and the like. In one example embodiment, the GPS installed in the UE 101 enables the channel manager platform 109 to determine, for example, position, destination, heading, context, for at least one UE 101. Then, the channel manager platform 109 may filter hotel information and offers based on location information for at least one user of the UE 101.

Further, various elements of the system 100 may communicate with each other through a communication network 107. The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular communication network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), vehicle controller area network (CAN bus), and the like, or any combination thereof.

In one embodiment, the channel manager platform 109 may be a platform with multiple interconnected components. The channel manager platform 109 may include one or more servers, intelligent networking devices, computing devices, components and corresponding software for providing points to at least one registered user for acquisition of a registered service, wherein payment may be partially made through automated redemption of the points from at least one point account. In addition, it is noted that the channel manager platform 109 may be a separate entity of the system 100, a part of the one or more services 115a-115n (collectively referred to as services 115) of the services platform 113, or the UE 101.

In one embodiment, the channel manager platform 109 may manage a loyalty program for registered users booking a service with one of the participating hotels. In another embodiment, the channel manager platform 109 may provide a cross-reservation management of the one or more participating hotels amongst their registered users. In one example embodiment, the channel manager platform 109 may consist of a responsive website to explain registered users and/or potential users on the loyalty/rewards programs, and the hotels on the cross-reservation management. There can also be a responsive backend for service users (e.g., hotel users), registered members, etc. In one scenario, the website is completely mobile responsive (e.g., optimized for UE 101's). In another scenario, the homepage of the website provides detailed explanation of the service being rendered. In a further scenario, the homepage includes: (a) login features, (b) a simple registration form, (c) a frequently asked questions pages, (d) terms and conditions, and (e) contact information. In one example embodiment, one or more hotels may click the “contact us” tab in the website to ask for hotel membership. The backend components of the website for hotels can include: (a) a contracting section, (b) a section on reservation history, (c) a section on hotel point transaction history, (d) a section on accounting and (e) an ability to confirm reservations section. In one scenario, a hotel while doing the set-up may automatically receive the terms and conditions in real-time so the hotel can get immediate access to the hotel manager backend portal and start using the system. In another example embodiment, a member (e.g., a customer) may fill a short registration form available in the website as a part of the login widget. The backend components of the website for customers can include: (a) a point account balance section, (b) a profile management section, (c) a section to change password, (d) a section to upload photos, (e) a reservation history section, (f) a history of point transaction section, (g) a contact and feedback features, (h) a location based hotel browser and best offers features, etc. In one scenario, a customer while setting-up an account may automatically receive the terms and conditions in real time and can get immediate access to the system. In a further example embodiment, the website may include one or more sections for their administrative staff. The section may comprise of: (a) a hotels management section, (b) a reservation history with filters section, (c) members listing and management section, (d) accounting section, and (e) reporting section.

In one embodiment, the channel manager platform 109 provides a cross-reservation management to the participating hotels by providing loyalty points or reward points to their customers. In one embodiment, the channel manager platform 109 updates data records to indicate loyalty points or reward points for a customer of at least one participating hotel. Then, the loyalty points or reward points are transferred to the point account associated with the customer. The channel manager platform 109 maintains a close association with the participating hotels, customers and the booking engine to update status information in real-time.

In one embodiment, the channel manager platform 109 may store every reservation in its system immediately after a reservation has been successfully placed. The channel manager platform 109 may track two different flags (with potential values listed):
Hotel status: {new, valid, invalid}
Client status: {new, confirmed, disputed}

The channel manager platform 109 may set “new” as the default value for both flags. The manager of the participating hotels are responsible for maintaining the hotel status and the clients are responsible for maintaining the client status (e.g., manage his/her profile, etc.). In another embodiment, the channel manager platform 109 may setup a minimum usable amount of points for members and may also setup a buy-back minimum for hotels.

In one embodiment, the channel manager platform 109 calculates points for one or more members. In one embodiment, there are few constants playing role in the point system, as follows:
100 points=$1
Commission to points ratio=50% (part of commission which goes to the customer in form of points)
Point payment minimum=500 (when paying with points, the number of points used must be higher or equal to 500).
Discounted booking default point value: 100 points=$3 (this can be changed by hotel manager in discount definition section).

In one example embodiment, user A is an authenticated member of the hotel booking service and he is going to make a booking via the booking engine of the channel manager platform 109. He has collected 30,000 points on his point account. The reservation amount is $200 and he is going to pay 10,000 points to get a lower price. The hotel booking service of the channel manager platform 109 has a 15% commission negotiated with the hotel.
Amount paid by points A (discount)=10000/100=$100
New (discounted) total for the reservation=$200−$100=$100
Service providers commission=$100*15%=$15
Points earned by user A=$15*50%*100=750 points
Payment for a hotel=$100+10000 points.

In another example embodiment, user B is an authenticated member of the hotel booking service and she is going to make a booking via the booking engine of the channel manager platform 109. She has 30,000 points collected on her point account. The reservation amount is $200, and hotel booking service of the channel manager platform 109 has a 15% commission negotiated with the hotel. In this example following details about the reservation are known:

| | | | |
|---|---|---|---|
| Date | 2015 Oct. 22 | 2015 Oct. 23 | 2015 Oct. 24 |
| Amount | $60 | $60 | $60 |
| Custom Discount | 10% | 10% | 0 |
| (defined by hotel in the | | | |
| backend) | | | |

In the above example, the maximum custom discount available for the reservation=$6+$6+0=$12. The amount of points needed to get whole custom discount=$12/($3−$1)*100=600 points. The increased value of 100 points is $3 (by default) and normal amount of 100 points is $1 USD. It means that custom discount is distributed as $2 extra per each 100 points (applies to first 600 points only in this example).

In one scenario, if user B spends 600 points then the channel manager platform 109 performs the following calculations:
Points spent=600
Discount=600*$3/100=$18
Value of points for a hotel=600*$1/100=$6
Discount provided by hotel (hotel expense)=$18−$6=$12.

In another scenario, if user B spends 1000 points then the channel manager platform 109 performs the following calculations:
Points spent=1000
Discount=600*$3/100+400*$1/100=$18+$4=$22
Value of points for a hotel=1000*$1/100=$10
Discount provided by hotel (hotel expense)=$22−$10=$12.

In one example embodiment, Hotel A is located in Czech Republic and its base currency is CZK. If the amount of booking is 6,000 CZK, and the user A is going to pay half of that with his points, the channel manager platform 109 performs the following calculations:
Booking time exchange rate: $1=25 CZK
Price in US Dollar=6000 CZK/25=$240
Amount paid by points=$120=12,000 points=3000 CZK
Amount paid by Credit Card=3000 CZK
Hotel is going to collect: 3000 CZK+12,000 points.

In one scenario, hotel A decides to sell the points a month later to the hotel booking services. At that point, the channel manager platform 109 performs the following calculations:
Current exchange rate: $1=22 CZK
Amount of points to be sold=12,000 pts=$120
Amount in CZK=2640 CZK
Lost for a hotel=3000 CZK−2640 CZK=360 CZK
Percentage lost=360/3000=12%.

As shown in the above example, there is a currency exchange related risk for a hotel. If the commission was 12% then the loss would be eliminated, and the service provider only collects commission for that part of a reservation which is paid directly by money. If the commission was less than 12% (which is more likely) there would be a loss on hotel side. However, if the exchange rate is switched in the example then hotel gets 409 CZK more. Since currency rates are frequently changing, the channel manager platform 109 constantly monitors the exchange rate fluctuations and may alert the required parties.

In one embodiment, the content repository 111 may store and manage any multiple types of information that can provide means for aiding in the content provisioning and sharing process. In one example embodiment, the content repository 111 may, for instance, be utilized to access and/or store user information, such as user identifiers, passwords, device information associated with users, payment resource information associated with users, such as credit cards, debit cards, banks, points, etc. In another example embodiment, the content repository 111 may, for instance be utilized to access and/or store information regarding services, offers (e.g., discounts), merchant-specific loyalty/rewards programs, etc. The information stored within the content repository 111 may also be categorized or otherwise indexed with respect to geographic regions such that, for example, specific offers may be provided with respect to specific geographic regions.

The services platform 113 may include any type of services. By way of example, the services platform 113 may include travel planning services/application, social networking services/application, content (e.g., audio, video, images, etc.) provisioning services/application, application services/application, storage services/application, contextual information determination services/application, location based services/application, etc. In one embodiment, the services platform 113 may interact with the UE 101, the channel manager platform 109 and the content provider 117 to supplement or aid in the processing of the content information. In one embodiment, the services platform 113 may be implemented or embedded in the channel manager platform 109 or in its functions.

By way of example, the services 115 may be an online service that reflects interests and/or activities of users. The services 115 allow users to share contact information, location information, user profile information, activity information, contextual information, historical user information and interests within their individual networks, and provides for data portability. In one example embodiment, the services 115 may assist in providing the channel manager platform 109 with information on travel plans of the at least one user, history of hotel reservations for the at least one user, history of point transactions for the at least one user, and a variety of additional information.

In one embodiment, the hotel booking systems 119 is used by the participating hotels to manage their inventory, rates, occupancy, etc. In another embodiment, the hotel booking systems 119 is an automated system that tracks bookings or reservations of their resources (e.g., rooms) to gather real time knowledge of occupancy or utilization rates. In such manner, the hotel booking systems 119 maintains reservation information, availability information, cost information, data records, or a combination thereof for one or more rooms of one or more participating hotels. In a further embodiment, the hotel booking systems 119 interfaces directly with the channel manager platform 109 and/or the consumer requests received from online and/or client applications.

In one embodiment, the hotel booking systems 119 stores a data table that provides exchange rates for converting points earned at one hotel to points or payment amounts for another hotel. In another embodiment, the hotel booking systems 119 stores constants that are fundamental in calculating the point system, for example, (a) 100 points totals $1, (b) 500 points as the minimum points required to make payments, (c) 50% as a commission to the customer in the form of points for a confirmed reservation, (d) discounted default values, etc. In a further embodiment, the hotel booking systems 119 stores commission information negotiated with the participating hotels. In one scenario, the channel manager platform 109 provides higher points to a user for booking a room in a hotel that provides higher commission amount to the service provider.

By way of example, the UE 101, the channel manager platform 109 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

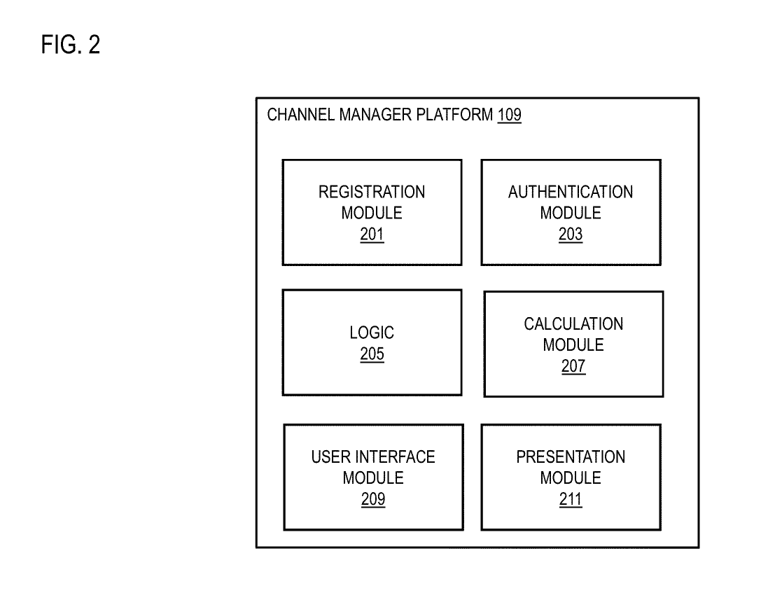

FIG. 2 is a diagram of the components of the channel manager platform 109, according to one example embodiment. By way of example, the channel manager platform 109 includes one or more components for providing points to at least one registered user for acquisition of a registered service, wherein payment may be partially made through automated redemption of the points from at least one point account. It is contemplated that the functions of these components may be combined in one or more components or performed by other components of equivalent functionality. In one embodiment, the channel manager platform 109 comprises one or more registration modules 201, authentication modules 203, logic 205, calculation modules 207, user interface modules 209, and presentation modules 211, or any combination thereof.

In one embodiment, the registration module 201 may register at least one user of at least one UE 101, actual communication identifiers associated with at least one UE 101, or a combination thereof. In one scenario, the actual communication identifiers include email address, phone number, social media information, or a combination thereof associated with at least one user of the at least one UE 101. In another embodiment, the registration process may be performed through automated association of profile settings maintained with an IP address, a carrier detection signal of a user device, mobile directory number (MDN), subscriber identity module (SIM), radio frequency identifier (RFID) tag or other identifier. In one scenario, the registration module 201 may provide at least one user and/or UE 101 with a username and a password of their choice upon successful registration.

In one embodiment, UE 101 which desires to connect to, for example, the services provided by the channel manager platform 109, first authenticates itself against the authentication module 203 through the communication network 107. In one scenario, the UE 101 transmits its credentials to the authentication module 203 to be used for authentication purposes. In one example embodiment, the credentials of the UE 101 can include username and password. However, it is contemplated that any credentials can be used for authentication purposes, such as biometrics, one time password, network address filtering, etc. The authentication module 203 examines and validates the received credentials of the UE 101. In one embodiment, the authentication module 203 can include a single sign-on authentication process that enables a user (e.g., a user device, a client application, user of a user device, etc.) to authenticate once and gain access to resources of multiple software, applications, servers, etc., without being prompted to authenticate itself again at each of the resources.

In one embodiment, the logic module 205 may manage tasks, including tasks performed by the other modules. For example, although the other modules may perform their actual tasks, the logic module 205 may determine when and how those tasks are performed or otherwise direct the other modules to perform the task. In one example embodiment, the logic module 205 may selectively route communications to at least one registered UE 101 based on device capability information, resource availability information, user configuration, or a combination thereof.

In one embodiment, the calculation module 207 may collect flat or relative commission for every reservation made by the registered members in the participating hotels. Then, the calculation module 207 may convert a fixed percentage (i.e., the percentage is same across all the hotels) of this commission into points. Subsequently, these converted points are deposited to the at least one member's point account based, at least in part, on a validation that the actual stay has been confirmed by the member. In one example embodiment, the at least one member may use these points to get a discount on later bookings in any participating hotel whereupon the channel manager platform 109 may transfer the points to the participating hotel's point account. Then, the participating hotels can sell these points to collect money from the channel manager platform 109. In another embodiment, the calculation module 207 may deposit the remainder of the commission as a profit. In a further embodiment, the calculation module 207 may determine a fixed internal value of the points for the participating hotels and the members, for example, $1 equals to 100 points. This can also be a default value of the points for the customers across all hotels. In one embodiment, the calculation module 207 may internally process transactions is US dollars or in points (whichever is equivalent) irrelevant to the location of the hotel or the currency of the customer. In another example embodiment, one or more participating hotels may define additional percentage discounts (custom discounts) per given dates and room types. Then, the calculation module 207 may incorporate the increased value of the points to get the additional percentage discount in the participating hotels.

In one embodiment, the user interface module 209 enables presentation of a graphical user interface (GUI) in at least one UE 101. The user interface module 209 employs various application programming interfaces (APIs) or other function calls corresponding to the applications 103 of UE 101, thus enabling the display of graphics primitives such as icons, menus, buttons, data entry fields, etc., for generating the user interface elements. In a further embodiment, the user interface module 209 may cause an interfacing of the guidance information with one or more users to include, at least in part, the one or more annotations, audio messages, or a combination thereof. In one example embodiment, the user interface module 209 may display banners (i.e., images with some advertisement content) in at least one UE 101 or at least one website. These banners may promote the services being rendered, and may redirect users to the registration page for the services being rendered. The user interface module 209 may present different banners linking to different registration pages based on the types of members (e.g., the participating hotels, the registered members, the potential members, etc.). In another example embodiment, the user interface module 209 may display a login widget in at least one UE 101 or a website (e.g., websites of the participating hotels or any websites rendering hotel booking services). The user interface module 209 ensures that the login widget is distinctive to be recognized by the users (e.g., members, visitors) and unobtrusive to avoid any negative user experiences while visiting the website. In addition, the login widget icon may also have a share function (linked to various social networking websites) and a registration function. In a further example embodiment, the user interface module 209 displays a booking widget in at least one UE 101 and/or at least one website rendering hotel booking services. The booking widget is visible only to the logged-in customers. The purpose of this UI element is to give information to the user regarding the rewards available and to use points in order to get a discount or perks.

In one embodiment, the presentation module 211 obtains a set of summary statistics and/or updates from the other modules. The presentation module 211 may present at least one user interface in at least one UE 101 and/or at least one website that allows the user to select at least one service (e.g., book a hotel). In one scenario, the presentation module 211 may generate a presentation of at least one notification in one or more UE 101 and/or at least one website requesting for access credentials. In another scenario, the presentation module 211 may cause a presentation of notification regarding granting, rejection, pending, or a combination thereof of access requests.

The above presented modules and components of the channel manager platform 109 can be implemented in hardware, firmware, software, or a combination thereof. Though depicted as a separate entity in FIG. 1, it is contemplated that the channel manager platform 109 may be implemented for direct operation by respective UE 101. As such, the channel manager platform 109 may generate direct signal inputs by way of the operating system of the UE 101 for interacting with the applications 103. In another embodiment, one or more of the modules 201-211 may be implemented for operation by respective UEs, as the channel manager platform 109, or combination thereof. Still further, the channel manager platform 109 may be integrated for direct operation with the services 115, such as in the form of a widget or applet, in accordance with an information and/or subscriber sharing arrangement. The various executions presented herein contemplate any and all arrangements and models.

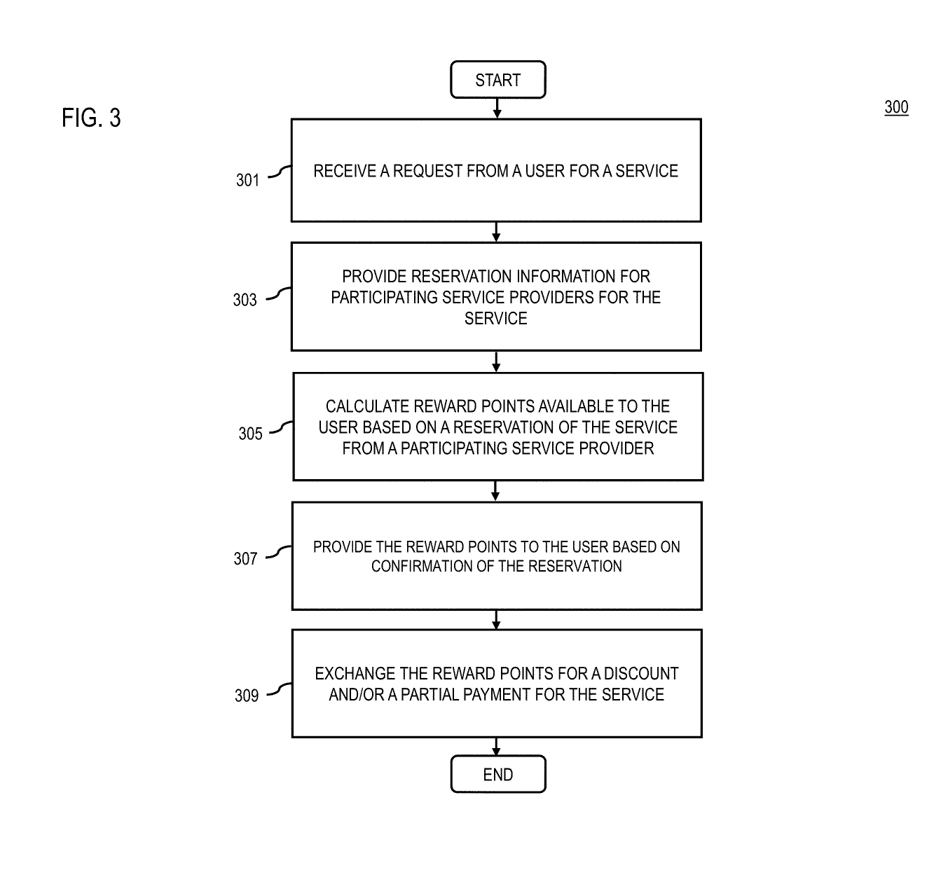

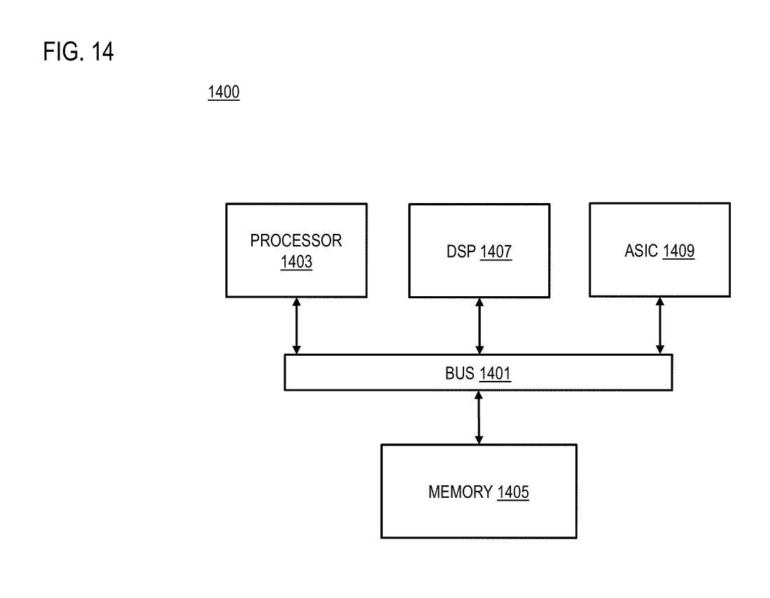

FIG. 3 is a flowchart of a process for providing points to a registered user for acquisition of a registered service, and exchanging the points as a partial payment for the registered service, according to one embodiment. In one embodiment, the channel manager platform 109 performs the process 300 and is implemented in, for instance, a chip set including a processor and a memory as shown in FIG. 14.

In step 301, the channel manager platform 109 receives a request from at least one user for at least one service. In one embodiment, the at least one user includes a registered user, a visiting user, or a combination thereof. In another embodiment, the at least one service includes a hotel booking service. In one example embodiment, a registered user A sends a request via his/her UE 101 for a hotel room in ABC city.

In step 303, the channel manager platform 109 provides reservation information for one or more participating service providers for the at least one service based, at least in part, on preference information of the at least one user. In one embodiment, the reservation information includes hotel information, hotel check-in time, hotel check-out time, hotel check-in date, hotel check-out date, room rates, or any other suitable data related to reservation management. In another embodiment, hotel information includes hotel names, hotel addresses, hotel amenities, hotel quality ratings, room availability and so on. In a further embodiment, preference information includes hotel preferences, room preferences, amenity preferences, pricing preferences, location preferences, or a combination thereof. In one example embodiment, the channel manager platform 109 may process user A's travel data (e.g., history of user A's external reservations, such as, theatre, sports facilities, museums, zoo, restaurants etc.) and preference information to provide user A with reservation information for one or more participating hotel in ABC city. In one scenario, the channel manager platform 109 determines that user A enjoys swimming and visiting museums. As a result, the channel manager platform 109 provides user A with reservation information for one or more participating hotels with swimming pools and has close proximity to museums.

In step 305, the channel manager platform 109 calculates one or more points available to the at least one user based, at least in part, on a reservation for the at least one service from at least one participating service provider. In one embodiment, the one or more points are rewards points for reserving a service from the participating service providers. In another embodiment, the one or more points are loyalty points for becoming a registered member of the booking service. In one embodiment, during calculation of the points there are few constants, such as:
100 points=$1;
Commission to points ratio=50% (part of commission which goes to the customer in form of points);
Point payment minimum=500 (when paying with points, the number of points used must be higher or equal to 500).
Discounted booking default point value: 100 points=$3 (this can be changed by hotel manager in discount definition section).

In another embodiment, the channel manager platform 109 provides higher points to user A for booking a room in a hotel that provides higher commission amount to the service provider. In one example embodiment, user A is a visiting or a guest user. The channel manager platform 109 may provide user A with loyalty points for registering with the system and becoming a registered user. In one scenario, channel manager platform 109 may provide user A with 10,000 points to register with the system. Then, user A may utilize these 10,000 points to get a lower price while booking a hotel room.

In step 307, the channel manager platform 109 provides the one or more points to the at least one user based, at least in part, on confirmation of the reservation for the at least one service. In one example embodiment, user A is provided with 10,000 points to his point account upon reserving a hotel room. Now, user A has a total of 40,000 points in his point account. The reservation amount for the hotel is $400 and he is going to pay 20,000 points to get a lower price. The hotel booking service of the channel manager platform 109 has a 15% commission negotiated with the hotel. Therefore, the calculation is as follows:
Amount paid by points (discount)=20000/100=$200
New (discounted) total for the reservation=$400−$200=$200
Service providers commission=$200*15%=$30
Points earned by User A=$30*50%*100=1500 points
Payment for a hotel=$200+20000 points.

In step 309, the channel manager platform 109 exchanges the one or more points for a discount, a partial payment, or a combination thereof for the at least one service based, at least in part, on a pre-set criteria, a purchase amount of the at least one service, or a combination thereof.

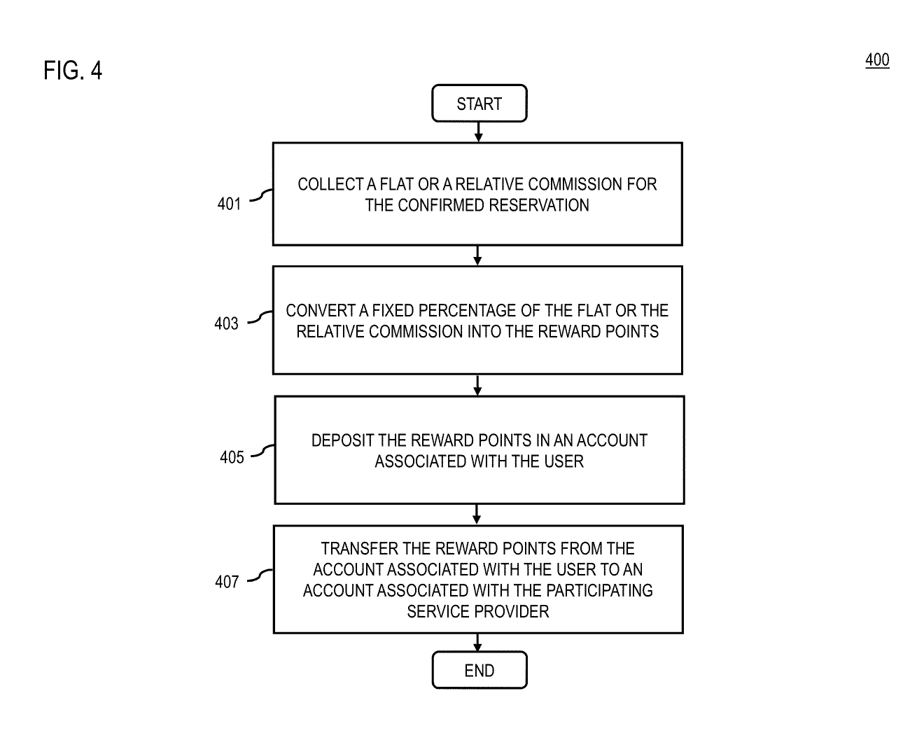

FIG. 4 is a flowchart of a process for calculating points for a registered user, and depositing the points in a point account associated with the registered user, according to one embodiment. In one embodiment, the channel manager platform 109 performs the process 400 and is implemented in, for instance, a chip set including a processor and a memory as shown in FIG. 14.

In step 401, the channel manager platform 109 calculates the one or more points by collecting a flat or a relative commission for the reservation confirmed by the at least one user. In one example embodiment, the channel manager platform 109 may have a fixed commission scheme negotiated with one or more participating hotels for every confirmed reservation. In another example embodiment, the channel manager platform 109 may have a relative commission for participating hotels giving higher commission to the service providers. Higher commission yields higher points for the users.

In step 403, the channel manager platform 109 calculates the one or more points by converting a fixed percentage of the flat or the relative commission into the one or more points. In one example embodiment, hotel booking service of the channel manager platform 109 has a 10% commission negotiated with a hotel. The commission is calculated on the discounted value of the reservation (i.e., reservation amount less amount paid by points). The calculation is as follows:
The reservation cost for a hotel room=$200
Amount paid by points=10,000/10=$100
New discounted value for the reservation=$200−$100=$100
Service providers commission=$100*10%*100=$10

In the above example, the service provider's commission is $10. Next, the channel manager platform 109 calculates commission which goes to the user in the form of reward points. For example, the commission to point's ratio is 50% of the service provider's commission. The calculation is as follows:
Points earned by the user=$10*50%*100=500 points

In step 405, the channel manager platform 109 deposits the one or more points in at least one account associated with the at least one user. In one example embodiment, the 500 points earned by the user is transferred to his or her account.

In step 407, the channel manager platform 109 exchanges the one or more points by transferring automatically the one or more points from the at least one account associated with the at least one user to at least one account associated with the at least one participating service provider based, at least in part, on confirmation of the reservation for the at least one service. In one embodiment, the one or more points are above the minimum threshold limit required for transferring the one or more points between accounts. In one example embodiment, the minimum points required to make a payment is 500 points. The user needs at least 500 points or more than 500 points to pay for a service.

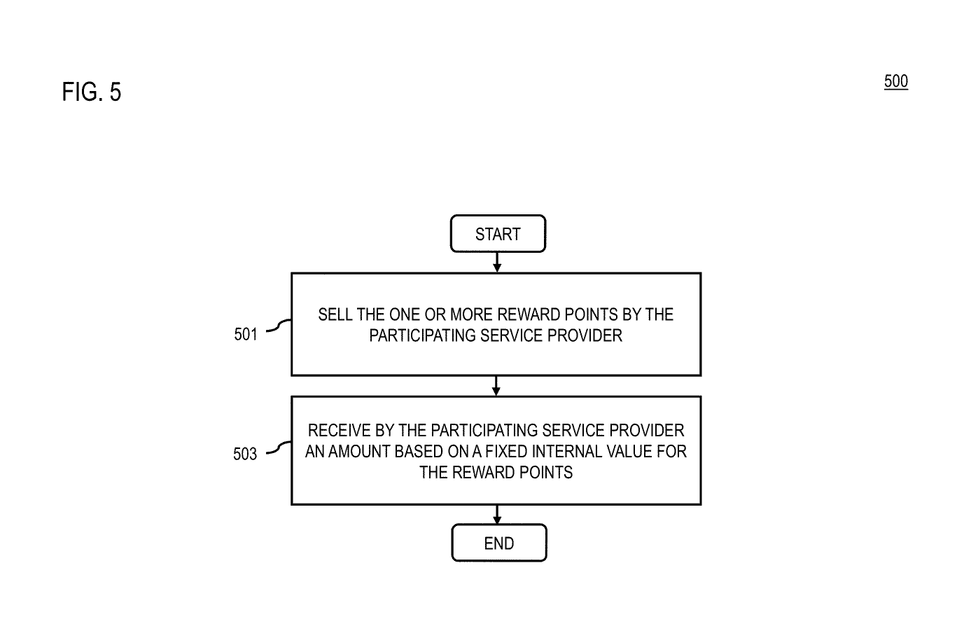

FIG. 5 is a flowchart of a process for selling one or more points by the participating service providers, according to one embodiment. In one embodiment, the channel manager platform 109 performs the process 500 and is implemented in, for instance, a chip set including a processor and a memory as shown in FIG. 14.

In step 501, the channel manager platform 109 transfers the one or more points of the at least one participating service provider. In one example embodiment, a participating hotel may transfer the one or more points from its account to the account of the channel manager platform 109 in exchange for an amount.

In step 503, the channel manager platform 109 provides the at least one participating service provider an amount based, at least in part, on a fixed internal value for the one or more points. In one example embodiment, the channel manager platform 109 may receive 10,000 points from the account of the participating hotel. Then, the channel manager platform 109 determines an amount for the points transferred by the participating hotel based on a fixed internal value, for example, $1 equals 100 points. Subsequently, the channel manager platform 109 transfers $100 to the account of the participating hotel.

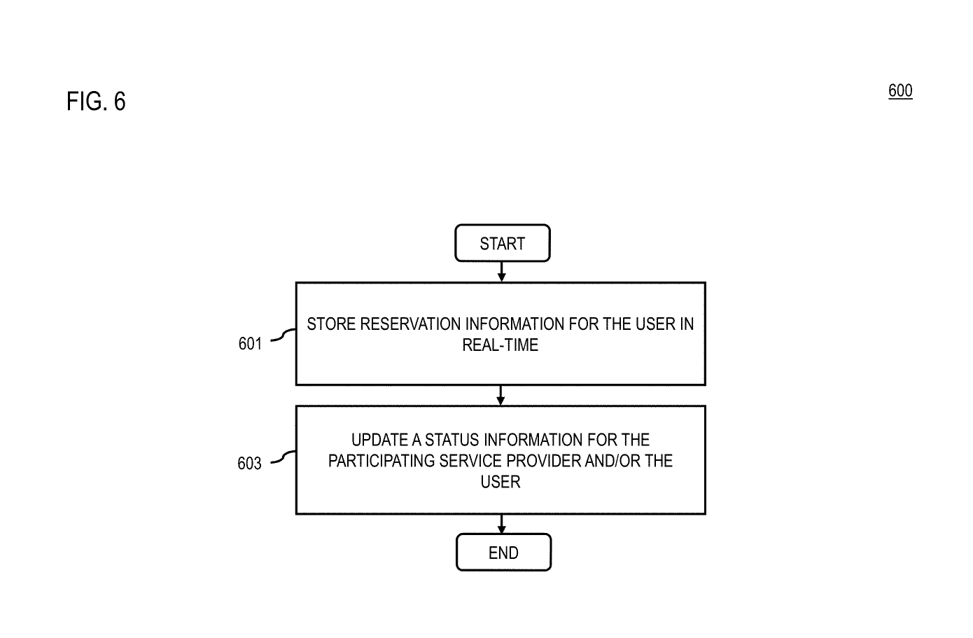

FIG. 6 is a flowchart of a process for storing reservation information and updating status information, according to one embodiment. In one embodiment, the channel manager platform 109 performs the process 600 and is implemented in, for instance, a chip set including a processor and a memory as shown in FIG. 14.

In step 601, the channel manager platform 109 stores reservation information for the at least one user in real-time. In one embodiment, the reservation information includes confirmed reservations, pending reservations, cancelled reservations, name of the hotel with confirmed reservations, name of the hotel with pending reservations, name of the hotel with cancelled reservations, or a combination thereof.

In step 603, the channel manager platform 109 updates a status information for the at least one participating service provider, the at least one user, or a combination thereof based, at least in part, on the confirmation of the reservation for the at least one service. In one example embodiment, user ABC may book room 123 at hotel XYZ. Then, the channel manager platform 109 may update the status information for room 123 at hotel XYZ as “booked.” Further, the channel manager platform 109 may update status information for user ABC as “reservation confirmed.”

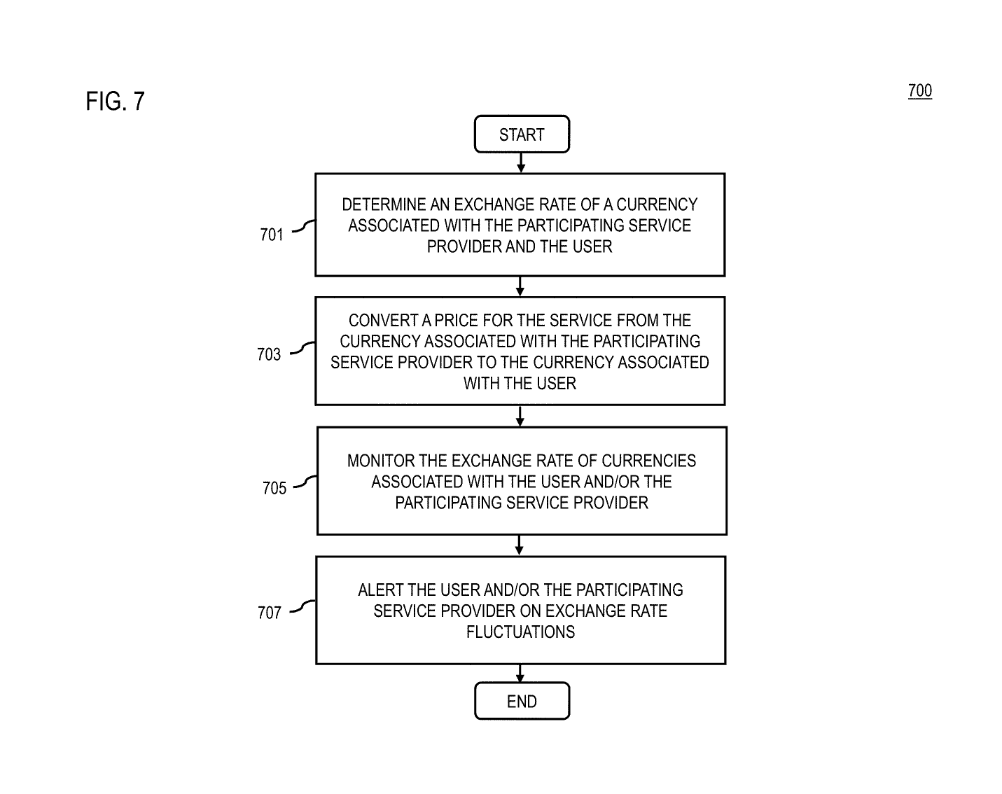

FIG. 7 is a flowchart of a process for monitoring exchange rate of currencies associated with participating service provider and the user, according to one embodiment. In one embodiment, the channel manager platform 109 performs the process 700 and is implemented in, for instance, a chip set including a processor and a memory as shown in FIG. 14.

In step 701, the channel manager platform 109 determines an exchange rate of a currency associated with the at least one participating service provider to a currency associated with the at least one user at time of confirming the reservation. In one example embodiment, user ABC in the United States books a room at hotel XYZ in India. The total cost for the room was 10,000 INR. The channel manager platform 109 determines the exchange rate between INR to dollar at the time of booking the room at hotel XYZ.

In step 703, the channel manager platform 109 converts a price for the at least one service from the currency associated with the at least one participating service provider to the currency associated with the at least one user based on the exchange rate. In one embodiment, the channel manager platform 109 maintains a data table in a database that provides exchange rates for converting points earned at one hotel to points or payment amounts for another hotel. In one example embodiment, hotel ABC is located in China and its base currency is RMB. The amount for booking a room at hotel ABC is 6,000 RMB, and user Z is going to pay half of the amount with his points. The hotel booking service of the channel manager platform 109 has a 15% commission negotiated with the hotel. Then, the channel manager platform 109 performs the following calculations:
Booking time exchange rate: $1=6 RMB
Price in US Dollar=6000 RMB/6=$1000
Amount paid by points=$500=50,000 points=3000 RMB
Amount paid by credit card=3000 RMB=$500
Hotel ABC is going to collect: 3000 RMB+50,000 points
Service providers commission=$500*10%=$50
Points earned by user Z=$50*50%*100=2500 points

The 2500 points earned by user Z combined with other accumulated points in his/her account may be utilized in his/her future booking with any participating hotels.

In step 705, the channel manager platform 109 monitors the exchange rate of one or more currencies associated with the at least one user, the at least one participating service provider, or a combination thereof continuously, periodically, according to a schedule, on demand, or a combination thereof.

In step 707, the channel manager platform 109 alerts the at least one user, the at least one participating service provider, or a combination thereof on exchange rate fluctuations. In one example embodiment, hotel ABC decides to sell the points a month later to the hotel booking services. At that point, the channel manager platform 109 performs the following calculations:
Current exchange rate: $1=7 RMB
Amount of points to be sold=50,000 pts=$500
Amount in RMB=3500 RMB
Profit for a hotel=3500 RMB−3000 RMB=500 RMB

In the above example, hotel ABC made a profit of 500 RMB by deciding to sell the points a month later to the hotel booking services. The channel manager platform 109 assists the participating hotels in reaching sales decision by monitoring the exchange rate fluctuations. The channel manager platform 109 alerts the participating hotels in any currency exchange related risk, e.g., a drop in the exchange rate from RMG to US dollar.

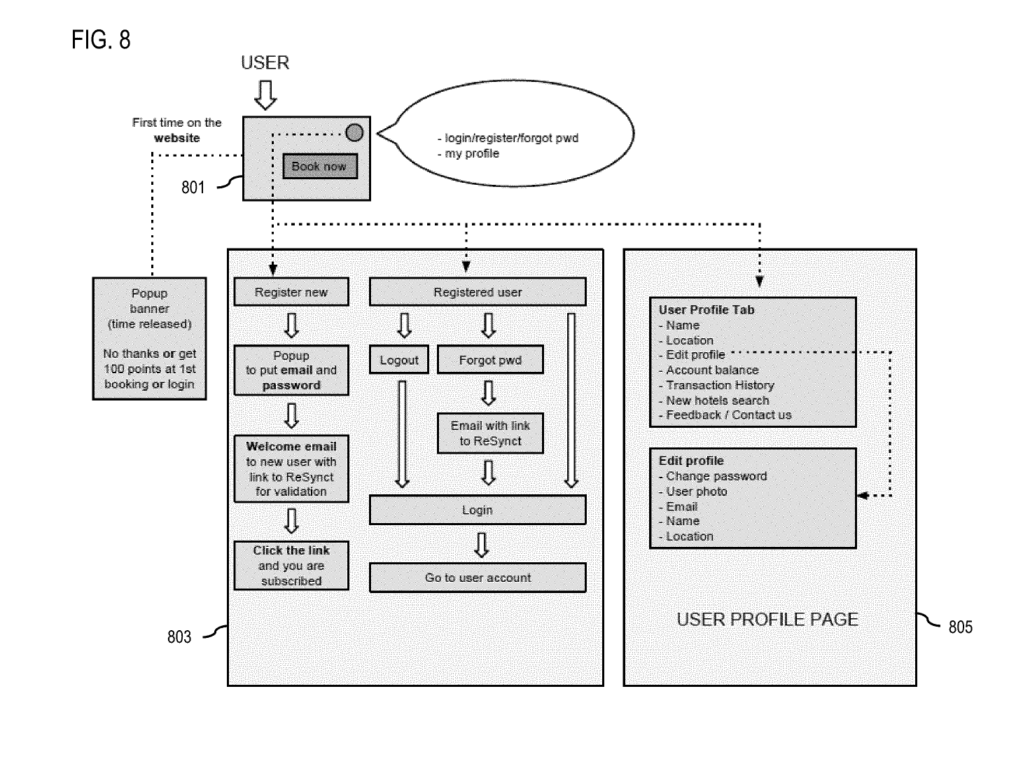

FIG. 8 is a diagram that represents a registration workflow, according to various embodiments. In one scenario, a visiting user may see a popup banner or a registration widget for a hotel booking service whereupon the user may create an account with the service (801). The registration process may involve redirecting the user to a profile page (805) wherein a user is requested to enter his/her profile information (e.g., name, address, email, username, password, etc.). Then, the email address of the user is verified (803), upon validation of the email address the visiting user becomes a member. As a member, the user can authenticate on the hotel's websites or in their booking engines, access his/her account, collect points for every reservation with the participating hotels (if the reservation is done through booking engine of the channel manager platform 109), and pay for the reservation with points (partially or completely). The collection and redemption of points is based on authentication and approval of the members by the channel manager platform 109. In another scenario, one or more hotel may register into the hotel booking program by signing up a contract whereupon their information is integrated into the hotel booking system of the channel manager platform 109. The registration of hotels may also involve placing login widget and banner of the hotel booking service on the hotel's website. Further, the participating hotels may have access to the hotel booking service's backend, history of the booking service's related reservations, accounting history, special discounts management, loyalty point, account transactions history, etc.

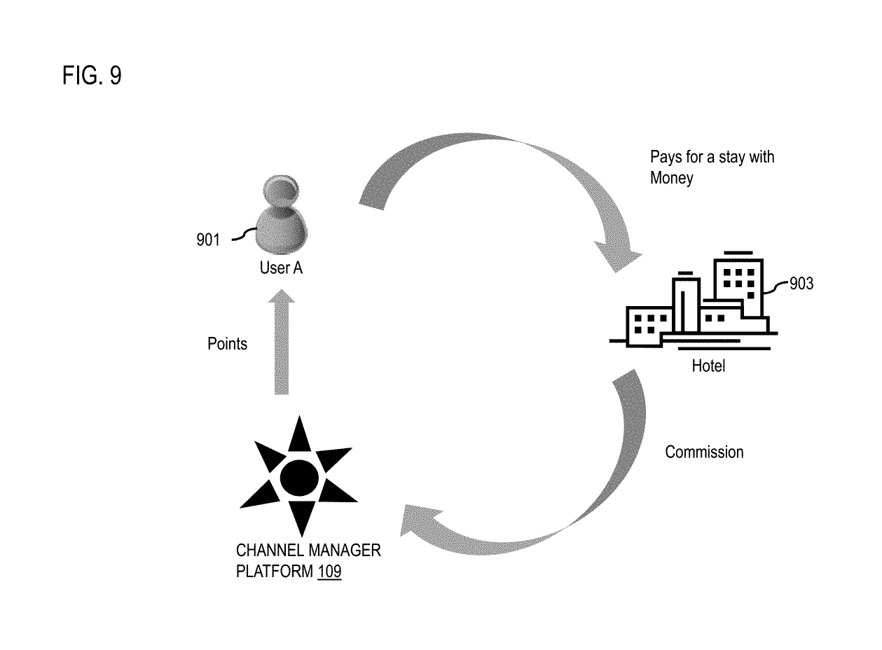

FIG. 9 is a diagram utilized in the processes of earning points for at least one registered user, according to various embodiments. In one scenario, a registered user A (910) reserves a room in a participating hotel (903). Every time a registered user makes a reservation (which is at least partially paid with money) in any participating hotels, he/she earns certain amount of points. As discussed, the channel manager platform 109 collects a flat or relative commission for every reservation made by the registered users in the participating hotels. In one scenario, the higher the commission amount to the service provider, the higher the point reward to the members for the reservation with a participating hotel (i.e., hotels giving higher commission to the service provider is more attractive for members). Subsequently, the channel manager platform 109 converts a fixed percentage of the received commission into points for user A (901). These converted points are deposited to user A's (901) point account.

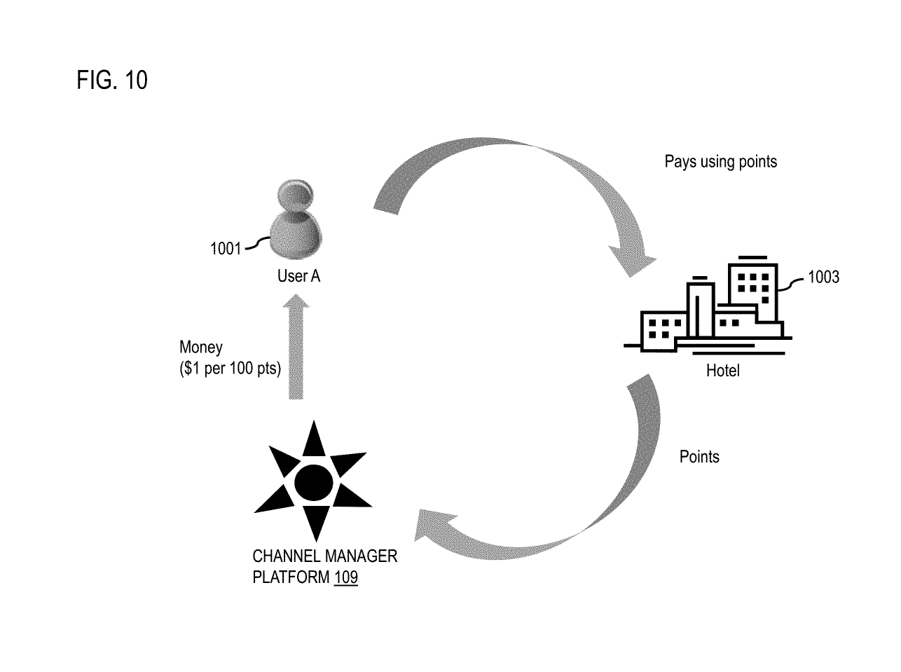

FIG. 10 is a diagram utilized in the processes of redeeming points for at least one registered user, according to various embodiments. In one scenario, a registered user A (1001) may use his/her points to get a discount on later bookings in any participating hotel (1003). The channel manager platform 109 may determine a fixed internal value of the points for their members, for example, $1 equals to 100 points. In one example embodiment, user A (1001) may have 1,000 points from previous transactions. If user A (1001) spends $100 while booking a room in a hotel (1003), the channel manager platform 109 may transfer user A's (1001) points (i.e., 1,000 points) to the participating hotel's (1003) point account. Since user A used points to get a discount, these used points are immediately removed from members' account ensuring that the members cannot use these points for making another reservation. These points are not immediately added to the hotel's account, but are deemed “pending” with the reservation itself. Once, the reservation is confirmed, the participating hotels can sell these points to the collect money from the channel manager platform 109 (e.g., the hotel may generate invoices for the valid and confirmed reservation that was not invoiced). In another scenario, the channel manager platform 109 may offer special relative discounts for specific dates and rooms to motivate members to collect points and for hotels to invest. In other words customer gets extra discount only in case he/she pays with points for the discounted reservation (at least partially).

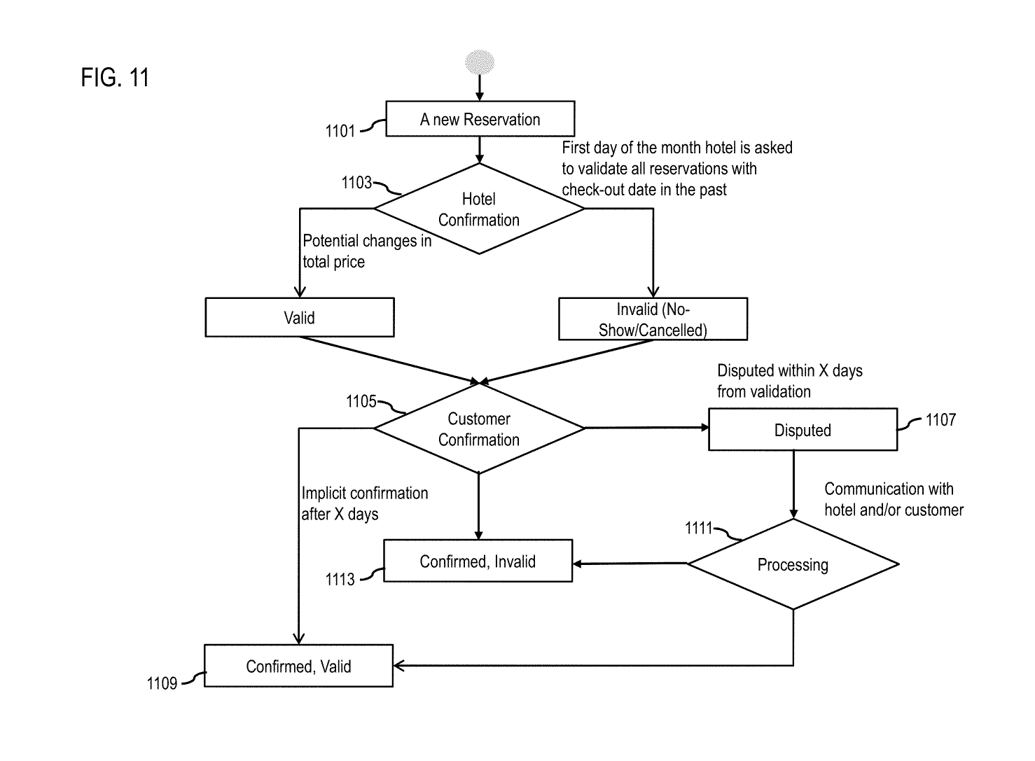

FIG. 11 is a flowchart of a process that depicts the reservation life cycle, according to one example embodiment. In one embodiment, the channel manager platform 109 may request one or more participating hotels to provide information on each and every reservation with check-out dates in the past at a particular time period (e.g., 1st day of every month). In step 1101, all new reservations with check-out dates in the past are sent to the hotel managers for validation (and possible edit). The hotel managers have a certain time period (e.g., validation deadline) to validate or invalidate the reservation (step 1103). In step 1105, all validated reservation (both valid and invalid) not confirmed by the customer is sent to the customer for confirmation. The customer has a certain time period (e.g., confirmation deadline) to confirm or dispute (step 1107) the reservation. In step 1109, the channel manager platform 109 may confirm all the validated reservations which were not disputed by the customer after a certain time period. In one scenario, all reservations not confirmed nor disputed by customers within the confirmation deadline is auto-confirmed. If a customer disputes the reservation (step 1107), he/she needs to provide a reason for the dispute, and the disputed reservation is sent for processing (step 1111). In addition, if a customer confirmation is determined to be invalid (step 1113) by the channel manager platform 109 it is sent for further processing (step 1111). Subsequently, a valid reservation that was disputed by a customer or an invalid confirmation may be confirmed and validated by the channel manager platform 109 (step 1109) after processing.

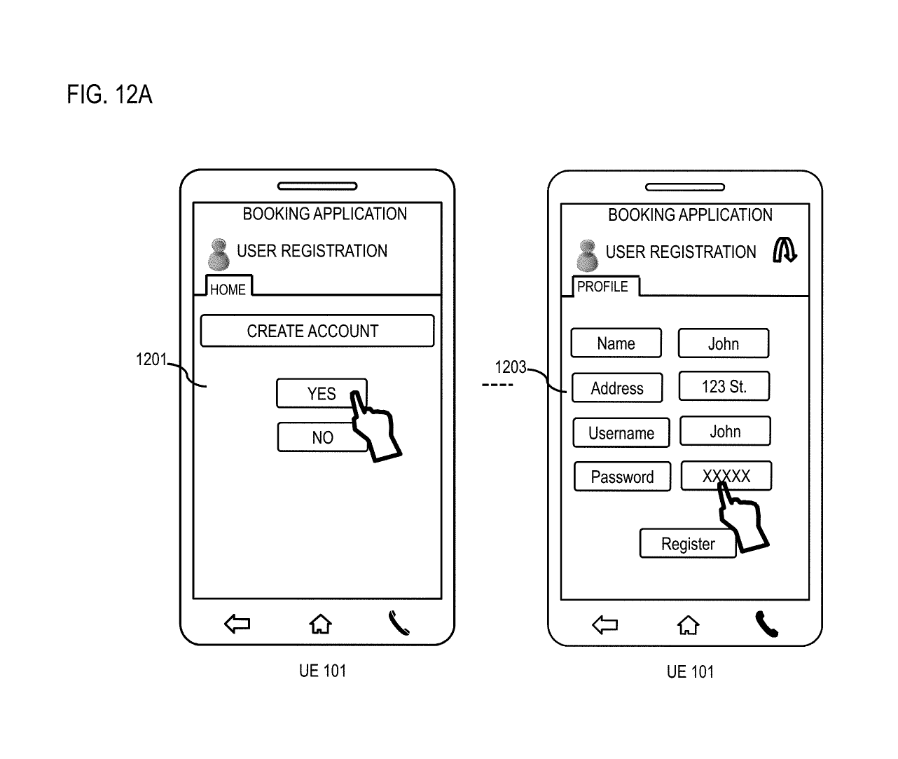

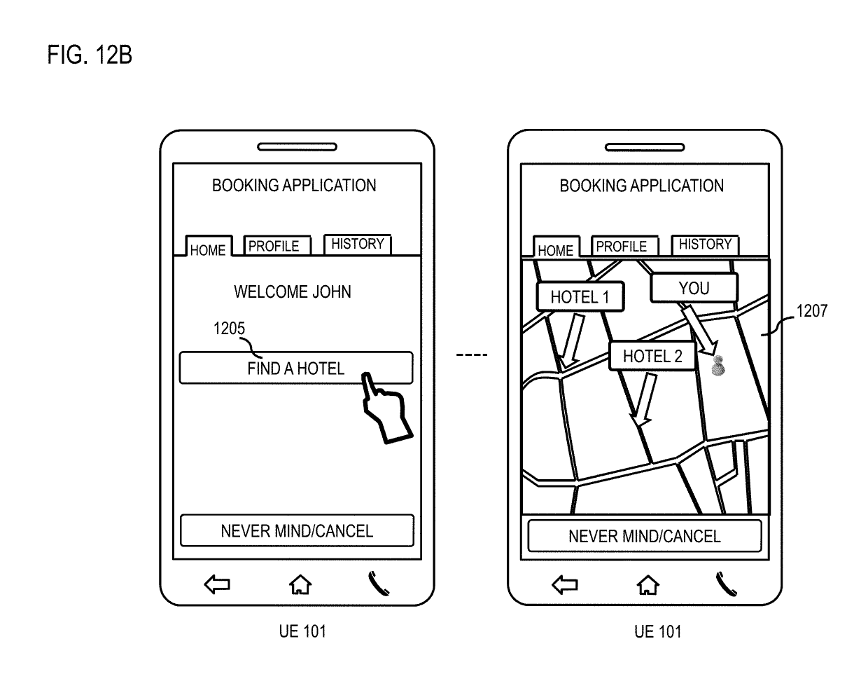

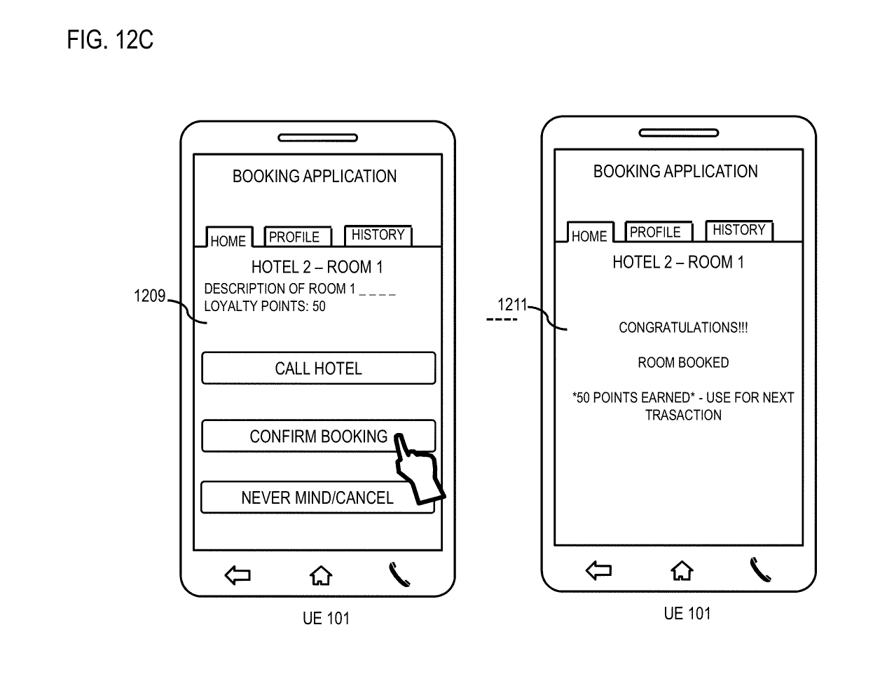

FIGS. 12A-12C illustrate diagrams of a user interface for user registration and making reservations, according to various example embodiments. Usually, a user may use his/her UE 101 to do a painstaking search for a nearby hotel keeping in mind location and/or pricing and/or current availability and/or services availability. FIGS. 12A-12C provides users with an opportunity to use a booking application in their UE 101 to check pricing, location, room availability, service availability and various other information associated with one or more participating hotels with one click. FIG. 12A represents a registration page for one or more users. A user may create an account (1201) by entering his/her profile information (1203) to access the services of the booking application. The registration page is simple and user friendly.

In FIG. 12B a user may send a request for a hotel search via his/her UE 101 by clicking “find a hotel” tab (1205). Then, the channel manager platform 109 may search amongst the participating hotels based in proximity information, pricing information, availability information, and so on. Subsequently, the user may be presented with a list on a map (1207) in his/her UE 101.

In FIG. 12C the channel manager platform 109 may display room information, pricing information, and points for at least one selected hotel (e.g., hotel 2) in the at least one UE 101 (1209). The user may book the hotel by clicking “confirm booking” tab whereupon the user may earn points upon booking confirmation (1211).

The processes described herein for providing points to at least one registered user for acquisition of a registered service, wherein payment may be partially made through automated redemption of the points from at least one point account may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

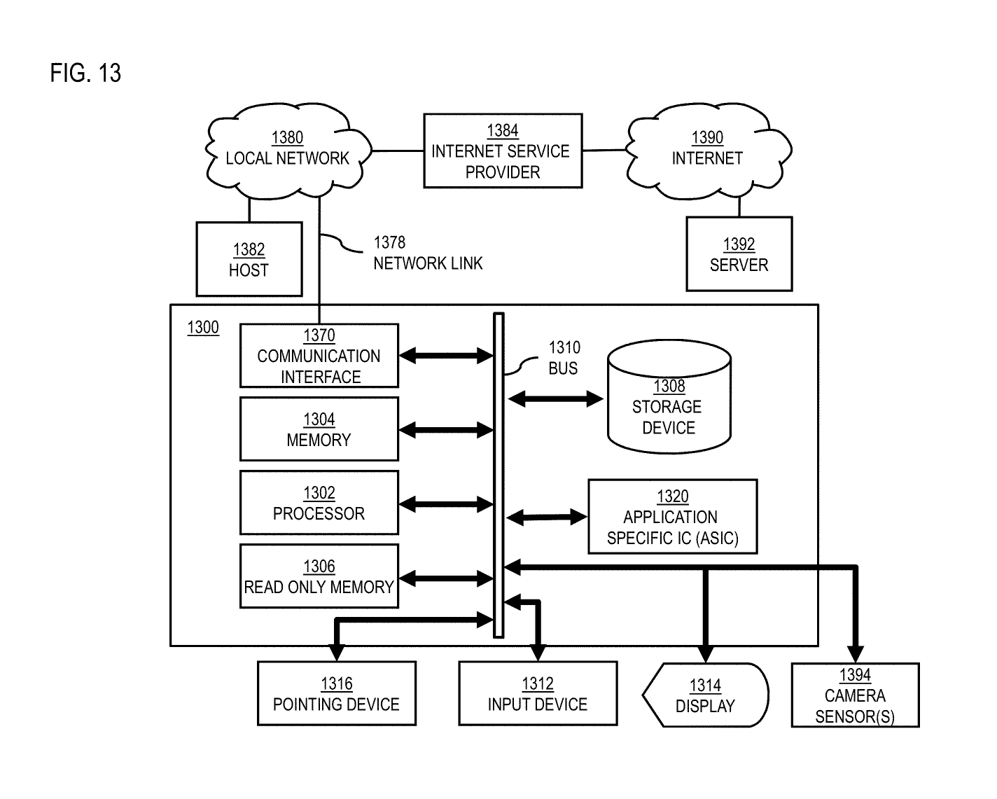

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to provide points to at least one registered user for acquisition of a registered service, wherein payment may be partially made through automated redemption of the points from at least one point account as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of providing points to at least one registered user for acquisition of a registered service, wherein payment may be partially made through automated redemption of the points from at least one point account.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to provide points to at least one registered user for acquisition of a registered service, wherein payment may be partially made through automated redemption of the points from at least one point account. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1300 also includes a memory 1304 coupled to bus 1310. The memory 1304, such as a random access memory (RAM) or any other dynamic storage device, stores information including processor instructions for providing points to at least one registered user for acquisition of a registered service, wherein payment may be partially made through automated redemption of the points from at least one point account. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for providing points to at least one registered user for acquisition of a registered service, wherein payment may be partially made through automated redemption of the points from at least one point account, is provided to the bus 1310 for use by the processor from an external input device 1312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314, and one or more camera sensors 1394 for capturing, recording and causing to store one or more still and/or moving images (e.g., videos, movies, etc.) which also may comprise audio recordings. In some embodiments, for example, in embodiments in which the computer system 1300 performs all functions automatically without human input, one or more of external input device 1312, display device 1314 and pointing device 1316 may be omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 107 for providing points to at least one registered user for acquisition of a registered service, wherein payment may be partially made through automated redemption of the points from at least one point account to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer system 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 14 illustrates a chip set or chip 1400 upon which an embodiment of the invention may be implemented. Chip set 1400 is programmed to provide points to at least one registered user for acquisition of a registered service, wherein payment may be partially made through automated redemption of the points from at least one point account as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of providing points to at least one registered user for acquisition of a registered service, wherein payment may be partially made through automated redemption of the points from at least one point account.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to provide points to at least one registered user for acquisition of a registered service, wherein payment may be partially made through automated redemption of the points from at least one point account. The memory 1405 also stores the data associated with or generated by the execution of the inventive steps.

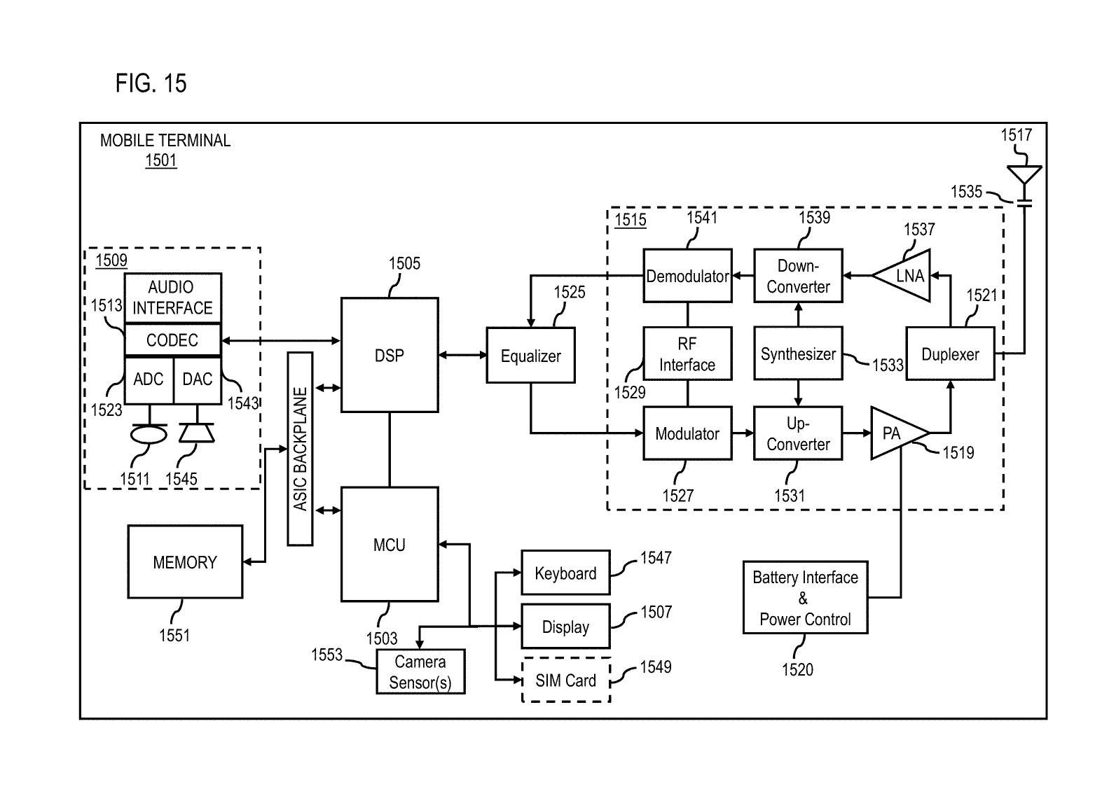

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of providing points to at least one registered user for acquisition of a registered service, wherein payment may be partially made through automated redemption of the points from at least one point account. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of providing points to at least one registered user for acquisition of a registered service, wherein payment may be partially made through automated redemption of the points from at least one point account. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to provide points to at least one registered user for acquisition of a registered service, wherein payment may be partially made through automated redemption of the points from at least one point account. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

Further, one or more camera sensors 1553 may be incorporated onto the mobile station 1501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request from at least one user for at least one service;
providing reservation information for one or more participating service providers for the at least one service based, at least in part, on preference information of the at least one user;
calculating one or more points available to the at least one user based, at least in part, on a reservation for the at least one service from at least one participating service provider;
providing the one or more points to the at least one user based, at least in part, on confirmation of the reservation for the at least one service; and
exchanging the one or more points for a discount, a partial payment, or a combination thereof for the at least one service based, at least in part, on a pre-set criteria, a purchase amount of the at least one service, or a combination thereof.

2. A method of claim 1, wherein the preference information includes hotel preferences, room preferences, amenity preferences, pricing preferences, location preferences, or a combination thereof.

3. A method of claim 1, wherein calculating the one or more points further comprising:
collecting a flat or a relative commission for the reservation confirmed by the at least one user; and
converting a fixed percentage of the flat or the relative commission into the one or more points.

4. A method of claim 1, wherein exchanging the one or more points further comprising:
depositing the one or more points in at least one account associated with the at least one user; and
transferring automatically the one or more points from the at least one account associated with the at least one user to at least one account associated with the at least one participating service provider based, at least in part, on confirmation of the reservation for the at least one service.

5. A method of claim 4, wherein the one or more points are above the minimum threshold limit required for transferring the one or more points between accounts.

6. A method of claim 4, further comprising:
transferring by the at least one participating service provider the one or more points; and
receiving by the at least one participating service provider an amount based, at least in part, on a fixed internal value for the one or more points.

7. A method of claim 1, further comprising:
storing reservation information for the at least one user in real-time,
wherein the reservation information includes confirmed reservations, pending reservations, cancelled reservations, or a combination thereof for the at least one service.

8. A method of claim 1, further comprising:
updating a status information for the at least one participating service provider, the at least one user, or a combination thereof based, at least in part, on the confirmation of the reservation for the at least one service.

9. A method of claim 1, further comprising:
determining an exchange rate of a currency associated with the at least one participating service provider to a currency associated with the at least one user at time of confirming the reservation; and
converting a price for the at least one service from the currency associated with the at least one participating service provider to the currency associated with the at least one user based on the exchange rate.

10. A method of claim 9, further comprising:
monitoring the exchange rate of one or more currencies associated with the at least one user, the at least one participating service provider, or a combination thereof continuously, periodically, according to a schedule, on demand, or a combination thereof; and
alerting the at least one user, the at least one participating service provider, or a combination thereof on exchange rate fluctuations.

11. An apparatus comprising:
at least one processor; and
at least one memory including computer program code for one or more programs, the at least one memory and the computer program code configured to, with the at least one processor, cause the apparatus to perform at least the following:
receive a request from at least one user for at least one service;
provide reservation information for one or more participating service providers for the at least one service based, at least in part, on preference information of the at least one user;
calculate one or more points available to the at least one user based, at least in part, on a reservation for the at least one service from at least one participating service provider;
provide the one or more points to the at least one user based, at least in part, on confirmation of the reservation for the at least one service; and
exchange the one or more points for a discount, a partial payment, or a combination thereof for the at least one service based, at least in part, on a pre-set criteria, a purchase amount of the at least one service, or a combination thereof.

12. An apparatus of claim 11, wherein calculating the one or more points the apparatus is further caused to:
collect a flat or a relative commission for the reservation confirmed by the at least one user; and
convert a fixed percentage of the flat or the relative commission into the one or more points.

13. An apparatus of claim 11, wherein exchanging the one or more points the apparatus is further caused to:
deposit the one or more points in at least one account associated with the at least one user; and
transfer automatically the one or more points from the at least one account associated with the at least one user to at least one account associated with the at least one participating service provider based, at least in part, on confirmation of the reservation for the at least one service.

14. An apparatus of claim 13, wherein the one or more points are above the minimum threshold limit required for transferring the one or more points between accounts.

15. An apparatus of claim 13, further comprising:
transfer by the at least one participating service provider the one or more points; and
receive by the at least one participating service provider an amount based, at least in part, on a fixed internal value for the one or more points.

16. An apparatus of claim 11, further comprising:
update a status information for the at least one participating service provider, the at least one user, or a combination thereof based, at least in part, on the confirmation of the reservation for the at least one service.

17. An apparatus of claim 11, further comprising:
determine an exchange rate of a currency associated with the at least one participating service provider to a currency associated with the at least one user at time of confirming the reservation; and
convert a price for the at least one service from the currency associated with the at least one participating service provider to the currency associated with the at least one user based on the exchange rate.

18. A non-transitory computer-readable storage medium carrying one or more sequences of one or more instructions which, when executed by one or more processors, cause an apparatus to perform:
receiving a request from at least one user for at least one service;
providing reservation information for one or more participating service providers for the at least one service based, at least in part, on preference information of the at least one user;
calculating one or more points available to the at least one user based, at least in part, on a reservation for the at least one service from at least one participating service provider;
providing the one or more points to the at least one user based, at least in part, on confirmation of the reservation for the at least one service; and
exchanging the one or more points for a discount, a partial payment, or a combination thereof for the at least one service based, at least in part, on a pre-set criteria, a purchase amount of the at least one service, or a combination thereof.

19. A non-transitory computer-readable storage medium of claim 18, wherein calculating the one or more points, the apparatus is further caused to:
collecting a flat or a relative commission for the reservation confirmed by the at least one user; and
converting a fixed percentage of the flat or the relative commission into the one or more points.

20. A non-transitory computer-readable storage medium of claim 18, wherein exchanging the one or more points, the apparatus is further caused to:
depositing the one or more points in at least one account associated with the at least one user; and
transferring automatically the one or more points from the at least one account associated with the at least one user to at least one account associated with the at least one participating service provider based, at least in part, on confirmation of the reservation for the at least one service.
